(19) United States
(12) Patent Application Publication
(10) Pub. No.: US 2022/0312737 A1
(43) Pub. Date: Oct. 6, 2022

(54) Pet Chew Toy

(71) Applicant: Chewsy Pets, LLC, Lone Tree, CO (US)

(72) Inventors: Maximillian Bekhit, Lone Tree, CO (US); Mitchell Bekhit, Thornton, CO (US); Jennifer Habashy, Phoenix, AZ (US)

(21) Appl. No.: 17/657,778

(22) Filed: Apr. 4, 2022

Related U.S. Application Data
(60) Provisional application No. 63/200,934, filed on Apr. 5, 2021.

(51) Int. Cl. A01K 15/02

(52) U.S. Cl. CPC A01K 15/026; F16B 2/20

(57) ABSTRACT

A pet chew toy is disclosed as it may include a connector housing. An example pet chew toy includes a first connector portion of the connector housing for attaching a first pet toy or accessory. The example pet chew toy also includes a second connector portion of the connector housing for attaching a second pet toy or accessory. The first connector portion and the second connector portion are each configured to removably interconnect to one another.

### RELATED PATENT APPLICATION

This application claims the priority filing benefit of U.S. Provisional Patent Application No. 63/200,934 filed Apr. 5, 2021 for “Pet Chew Toy” of Maximillian Bekhit, et al., hereby incorporated by reference in its entirety as though fully set forth herein.

### BACKGROUND

Spending for the pet industry reached nearly 100 billion dollars by 2020. A large portion of this spending is on pet toys and other devices to entertain pets, particularly while the owners are at work or otherwise out of the house.

Many pet toys are basic in structure, and lose their novelty for the pet in a short amount of time. As such, the pet may chew on rugs, furniture, or other household items even when there are several pet toys available for the pet.

In addition, many pet toys are made of cloth or inexpensive plastics and do not last long when chewed by dogs and other pets. Many of these pet toys easily come apart during play, and can be swallowed or pose a choking hazard for the pet, in addition to causing a general mess for the owner to clean.

### BRIEF DESCRIPTION OF THE DRAWINGS

FIG. 1 shows example pet chew toys.

FIG. 2 is a perspective view of a connector housing for an example pet chew toy in an connected configuration.

FIG. 3 is a perspective view of a connector housing for an example pet chew toy in disconnected configuration.

FIG. 4 is a transparent perspective view of a connector housing for an example pet chew toy showing an interconnection.

FIG. 5 is a cross-sectional perspective view of a connector housing for an example pet chew toy illustrating an attachment mechanism for the pet toy or accessory.

FIG. 6 is a cross-sectional perspective view of another connector housing for an example pet chew toy illustrating an attachment mechanism for the pet toy or accessory.

FIG. 7 is a perspective view of another example pet chew toy with the attachment mechanism of FIG. 6.

### DETAILED DESCRIPTION

A pet chew toy is disclosed. An example of the pet chew toy may be provided with a durable, safe-to-chew connector housing (e.g., made out of rubber or other material) to provide a modular, customizable pet toy. The example pet chew toy may be configured for easy, quick attachment of toys and accessories (e.g., plush toys, ropes, etc.). In an example, the pet chew toy may be provided with a handle that is strong enough for human interactive play with the pet (e.g., tug-of-war, etc).

An example pet chew toy includes a connector housing. The example pet chew toy also includes a first connector portion of the connector housing for attaching a first pet toy or accessory. The example pet chew toy also includes a second connector portion of the connector housing for attaching a second pet toy or accessory. The first connector portion and the second connector portion are each configured to removably interconnect to one another.

An example modular pet chew toy includes a connector housing. The example modular pet chew toy also includes a first connector portion of the connector housing for attaching a first pet toy or accessory. The example modular pet chew toy also includes a second connector portion of the connector housing for attaching a second pet toy or accessory. The example modular pet chew toy also includes a third connector portion of the connector housing for attaching a third pet toy or accessory. The first connector portion, the second connector portion, and the third connector portion are each configured to removably interconnect to one another.

A customizable pet chew toy includes a connector housing. The example customizable pet chew toy also includes a first connector portion of the connector housing for attaching a first chew toy. The example customizable pet chew toy also includes a second connector portion of the connector housing for attaching a second chew toy. The example customizable pet chew toy also includes a third connector portion of the connector housing for attaching a handle accessory. The first connector portion, the second connector portion, and the third connector portion are interchangeable with one another to customize the pet chew toy. In an example, the customizable pet chew toy is interchangeable between at least one of a first configuration of the first chew toy and the second chew toy, a second configuration of the first chew toy and the handle accessory, and a third configuration of the second chew toy and the handle.

Before continuing, it is noted that as used herein, the terms “includes” and “including” mean, but is not limited to, “includes” or “including” and “includes at least” or “including at least.” The term “based on” means “based on” and “based at least in part on.” In addition the term “chew” refers to the toy being suitable for a pet to chew and/or grasp with the pet's teeth, and is not limited to being used only with toys that the pet must chew on such as chewing its food.

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

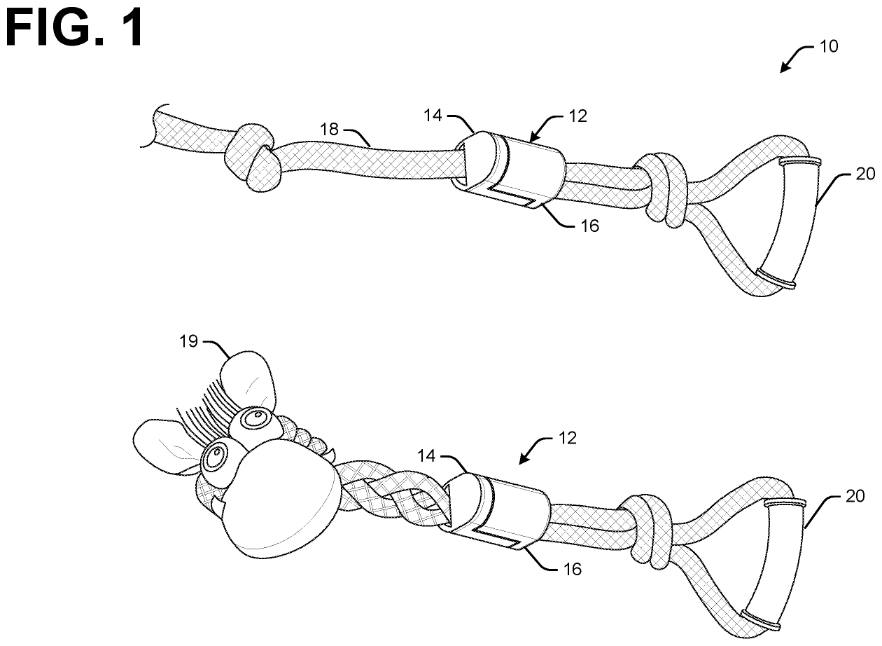

FIG. 1 shows example pet chew toys 10. An example pet chew toy 10 includes a connector housing 12 having a first connector portion 14 and a second connector portion 16. The first connector portion 14 of the connector housing 12 is for attaching a first pet toy or accessory 18 and 19. The second connector portion 16 of the connector housing 12 is for attaching a second pet toy or accessory 20. The first connector portion 14 and the second connector portion 16 are each configured to removably interconnect to one another. The connector housing 12 enables a modular, interchangeable pet chew toy (e.g., interchanging first pet toy or accessory 18 and 19 with the handle 20 shown in FIG. 1).

It is noted that the drawings of the pet chew toy 10 show the connector housing 12. The connector housing 12 may be further housed in a separate or outer housing, not shown (e.g., rubber or other chewable casing), that provides an exterior or cover and may have smooth, rounded ends over the connector portions. In an example, a rubber or other suitable material is provided to house all or some of one of the first connector portion 14 and the second connector portion 16. The rubber or other suitable material outer housing may itself be configured to be durable for a pet to chew on, thereby adding a third component for the pet chew toy 10.

Any suitable toys and/or accessories may be provided. In an example, the connector housing 12 of the pet chew toy 10 is configured to be attached to and interchanged with a variety of different soft, plush toys, and/or an assortment of accessories 18, 19. In an example, a handle portion 20 is provided for human engagement with the pet chew toy 10, such as for tug-of-war between a person and their pet. As such, the pet chew toy 10 is a customizable, modular pet toy.

In an example, the connector housing 12 enables easy, quick attachment and interchanging of a complementary device. As such, the pet chew toy 10 connects complementary devices that are safe for the pet to hold in its mouth and chew on, while itself being safe to chew on by the pet. Additionally, the pet chew toy 10 can hold a strong enough attachment for general play with the pet (e.g., tug-of-war).

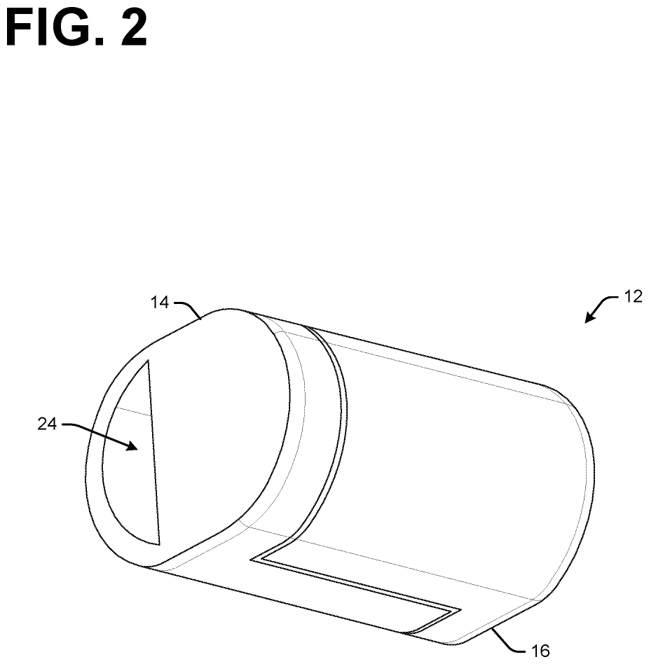

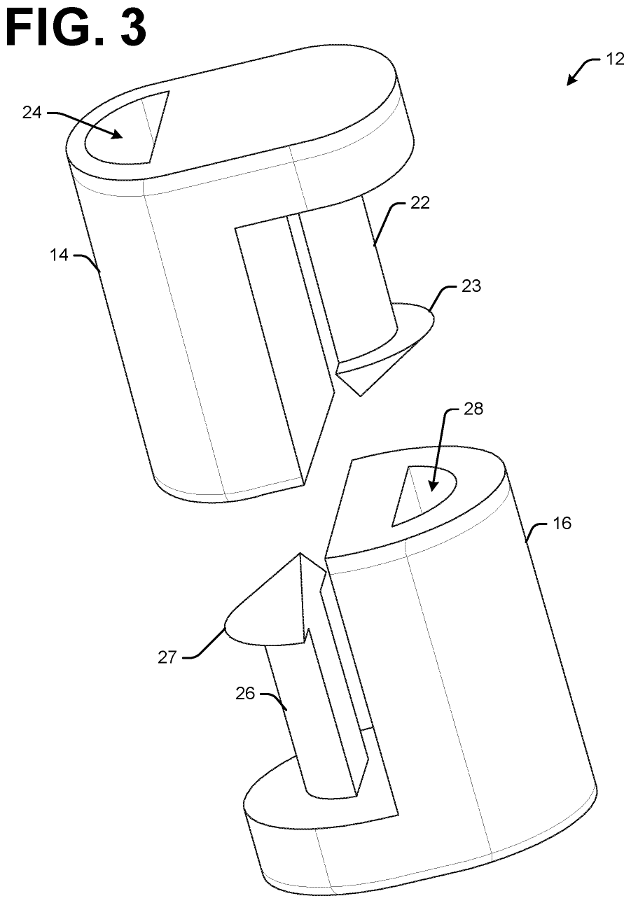

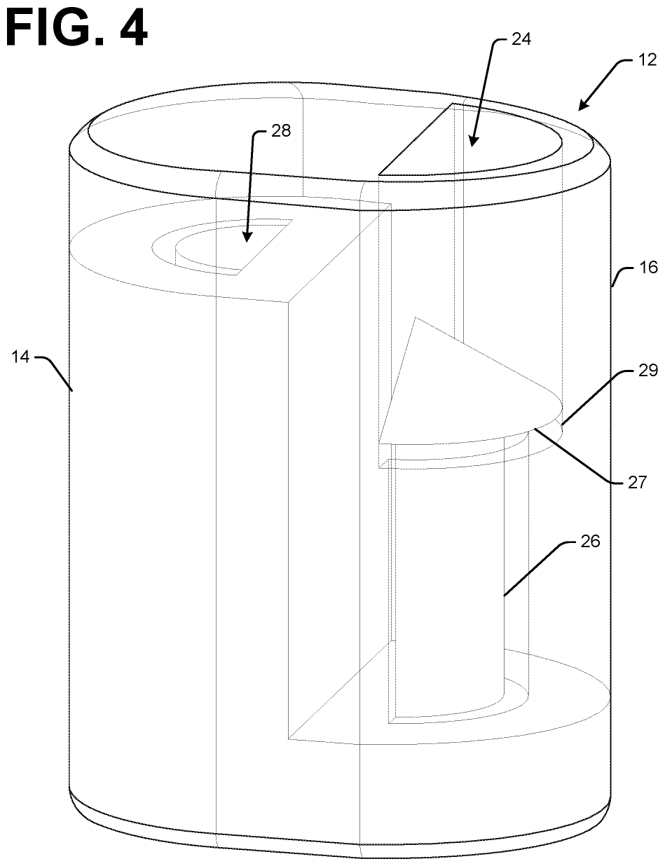

FIG. 2 is a perspective view of the connector housing 12 for the example pet chew toy 10 in an connected configuration. FIG. 3 is a perspective view of the connector housing 12 in disconnected configuration. FIG. 4 is a transparent perspective view of the connector housing 12 showing an interconnection.

The example pet chew toy 10 includes a first interconnection mechanism of the first connector portion 14 and a second interconnection mechanism of the second connector portion 16. In an example, the first interconnection mechanism mates with the second interconnection. The term “mates” refers broadly to any mechanical connection. In another example, the first interconnection mechanism interconnects with the second interconnection mechanism. The term “interconnects” refers broadly to any device used to connect two items or portions of an item together. In another example, the first interconnection mechanism engages with the second interconnection mechanism. The term “engages” refers broadly to suitable movement into a position of becoming operable, e.g., operable to hold the two portions together. In another example, the first interconnection mechanism interlocks with the second interconnection mechanism. The term “interlocks” refers to securement by overlapping or by fitting together projections and recesses.

In an example, the interconnection mechanism may be implemented with a first prong 22 on the first interconnection mechanism, and a first opening, cavity or channel 24 formed at least partly through the first interconnection mechanism. A second prong 26 may be provided on the second interconnection mechanism, and a second opening, cavity or channel 28 may be formed at least partly through the second interconnection mechanism. The first prong 22 slides into the second channel 28 formed in the second interconnection mechanism simultaneously with the second prong 26 sliding into the first channel 24 formed in the first interconnection mechanism.

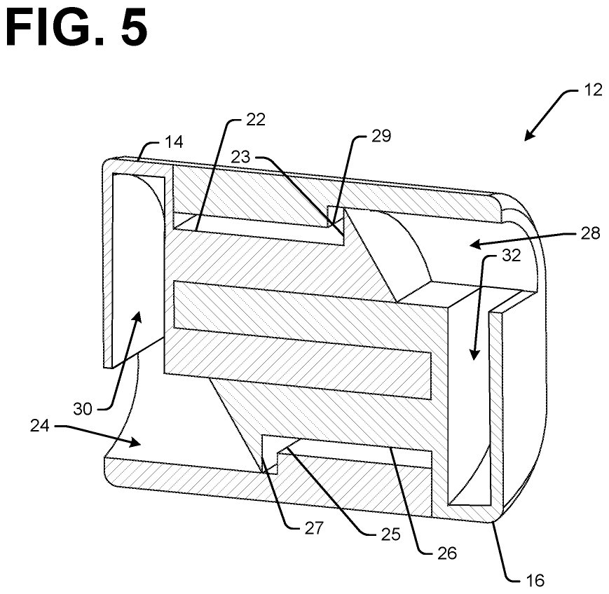

In an example, a first ridge 23 may be formed on an end portion of the first prong 22, and a first lip 25 may be formed inside the first channel 24 of the first interconnection mechanism (see, e.g., FIGS. 4 and 5). A second ridge 27 may be formed on an end portion of the second prong 26, and a second lip 29 may be formed inside the second channel 28 of the second interconnection mechanism (see, e.g., FIG. 5). The first ridge 23 slides over the second lip 29 formed inside the second channel 28 of the second interconnection mechanism. The second ridge 27 slides over the first lip 25 formed inside the first channel 24 of the first interconnection mechanism. The first and second ridges 23 and 27 may be slid simultaneously with one another, and when connected, lock the first interconnection mechanism to the second interconnection mechanism.

The connector portions 14, 16 are attached onto an interchangeable pet toy or accessory (see, e.g., FIG. 1). In an example, the ends of the toy or accessory can have loops (not shown) where a short ribbon of fabric (not shown) can be looped through and used for attachment to the connector portions 14, 16. This short ribbon of fabric enables the connector to be sewn or otherwise attached onto a soft pet toy or accessory (see, e.g., FIG. 1) and also attached to the connector portions 14, 16. In an example, the pet toy or accessory may be tied, clipped, sewn, formed in plastic, looped, knotted, or attached to the connector portions 14, 16 in any suitable manner. Additional examples for attaching the pet toy or accessory are described with reference to FIGS. 5-7. It is noted that the specific method of how the pet toy or accessory is attached to the connector portions 14, 16 is can be modified based on design considerations that will be well understood by those having ordinary skill in the art after becoming familiar with the teachings herein.

FIG. 5 is a cross-sectional perspective view of a connector housing 12 for an example pet chew toy 10 illustrating an attachment mechanism for the pet toy or accessory. In this example, a first gap or chamber 30 is formed in the first connector portion 14. The first pet toy or accessory is secured through opening 24 into the first chamber 30. A second chamber 32 is formed in the second connector portion 16. The second pet toy or accessory is secured through opening 28 into the second chamber 32. The pet toy or accessory may be secured in the corresponding chamber 30, 32 by any suitable means, including but not limited, by friction fit, compression, knotting, looping (e.g., through another opening, not shown), pet-safe adhesive, etc.

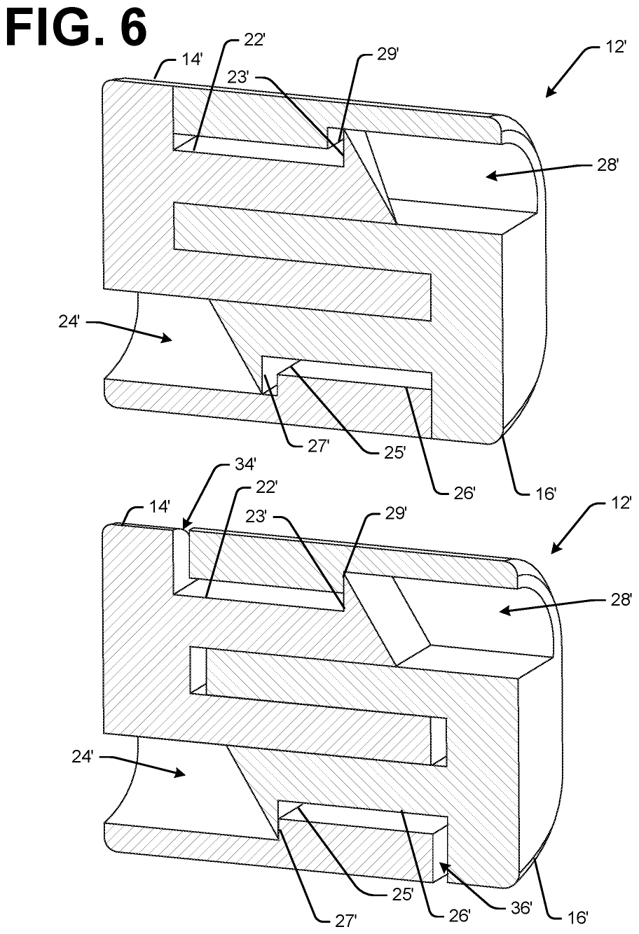

FIG. 6 is a cross-sectional perspective view of another connector housing 12′ for an example pet chew toy illustrating an attachment mechanism for the pet toy or accessory. Reference numbers for similar components already described above are designed by the prime reference and are not described again here for brevity.

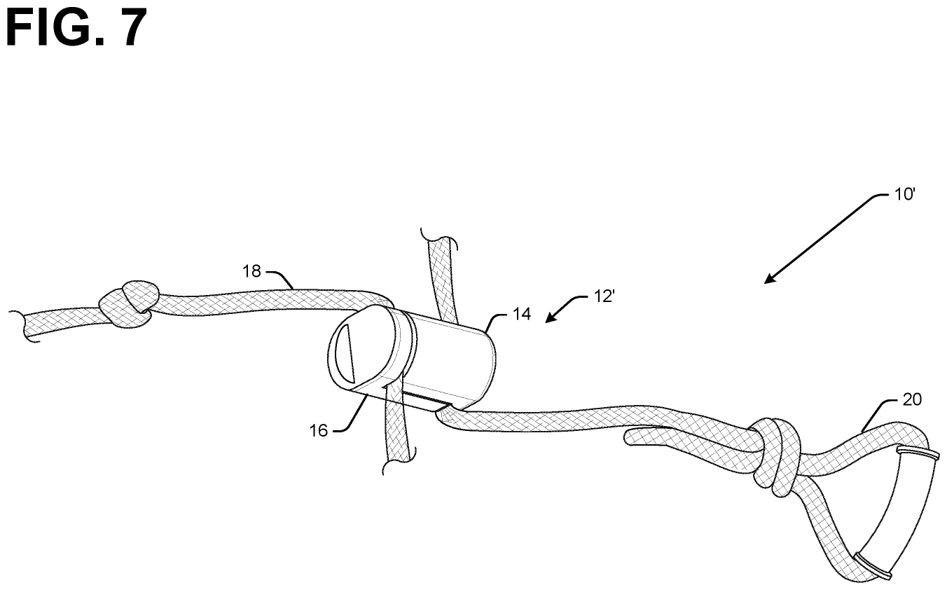

The top view in FIG. 6 shows the first prong 22′ and ridge 23′ inserted past the lip 29′ formed in the chamber 28′, and the second prong 26′ and ridge 27′ inserted past the lip 25′ formed in the chamber 24′. The bottom view in FIG. 6 shows the first connector 14′ pulled back from the second connector 16′ so that the ridge 23′ rests on the lip 29′ and the ridge 27′ rests on the lip 25′. This forms a gap 34′ and 36′ formed on each end of the connector housing 12′ between the connectors 14 and 16 in which a ribbon, loop, rope, etc. connected to or part of the pet toy or accessory can be inserted and held in place as shown in FIG. 7. FIG. 7 is a perspective view of another example pet chew toy 10′ with the attachment mechanism of FIG. 6. In this example, a first gap 32′ is formed between the first connector portion 14′ and the second connector portion 16′ on a first end of the connector housing 12′ when the first connector portion 14′ is connected to the second connector portion 16′. The first pet toy or accessory is secured (e.g., pinched and thereby held together) in the first gap 32′. A second gap 34 is formed between the first connector portion 14′ and the second connector portion 16′ on a second end of the connector housing 12′ when the first connector portion 14′ is connected to the second connector portion 16′. The second pet toy or accessory is secured (e.g., pinched and thereby held together) in the second gap 34′.

It is noted that the examples shown and described are provided for purposes of illustration and are not intended to be limiting. Still other examples are also contemplated.

1. A pet chew toy, comprising:
a connector housing;
a first connector portion of the connector housing for attaching a first pet toy or accessory;
a second connector portion of the connector housing for attaching a second pet toy or accessory;
wherein, the first connector portion and the second connector portion are each configured to removably interconnect to one another.

2. The pet chew toy of claim 1, wherein the first pet toy or accessory is a handle.

3. The pet chew toy of claim 1, wherein the first pet toy or accessory is a pet chew toy.

4. The pet chew toy of claim 1, wherein the first connector portion and the second connector portion are interchangeable with other connector portions.

5. The pet chew toy of claim 1, wherein the first connector portion and the second connector portion enable interchanging the first and second toys or accessories with other toys or accessories.

6. The pet chew toy of claim 1, wherein the connector housing is made of a rubber or other pet chew-safe material.

7. The pet chew toy of claim 1, further comprising a first interconnection mechanism of the first connector portion and a second interconnection mechanism of the second connector portion.

8. The pet chew toy of claim 7, wherein the first interconnection mechanism mates with the second interconnection.

9. The pet chew toy of claim 8, wherein the first interconnection mechanism interconnects with the second interconnection mechanism.

10. The pet chew toy of claim 9, wherein the first interconnection mechanism engages with the second interconnection mechanism.

11. The pet chew toy of claim 10, wherein the first interconnection mechanism interlocks with the second interconnection mechanism.

12. The pet chew toy of claim 1, further comprising:
a first prong on the first interconnection mechanism;
a first channel formed in the first interconnection mechanism;
a second prong on the second interconnection mechanism; and
a second channel formed in the second interconnection mechanism.

13. The pet chew toy of claim 12, wherein the first prong slides into the second channel formed in the second interconnection mechanism simultaneously with the second prong sliding into the first channel formed in the first interconnection mechanism.

14. The pet chew toy of claim 13, further comprising:
a first ridge formed on an end portion of the first prong;
a first lip formed inside the first channel of the first interconnection mechanism;
a second ridge formed on an end portion of the second prong; and
a second lip formed inside the second channel of the second interconnection mechanism.

15. The pet chew toy of claim 14, wherein the first ridge slides over the second lip formed inside the second channel of the second interconnection mechanism, and the second ridge slides over the first lip formed inside the first channel of the first interconnection mechanism, to lock the first interconnection mechanism to the second interconnection mechanism.

16. The pet chew toy of claim 1, further comprising:
a first gap formed between the first connector portion and the second connector portion on a first end of the connector housing when the first connector portion is connected to the second connector portion; and
a second gap formed between the first connector portion and the second connector portion on a second end of the connector housing when the first connector portion is connected to the second connector portion.

17. The pet chew toy of claim 16, wherein the first pet toy or accessory is secured in the first gap.

18. The pet chew toy of claim 16, wherein the second pet toy or accessory is secured in the second gap.

19. A modular pet chew toy, comprising:
a connector housing;
a first connector portion of the connector housing for attaching a first pet toy or accessory;
a second connector portion of the connector housing for attaching a second pet toy or accessory;
a third connector portion of the connector housing for attaching a third pet toy or accessory;
wherein, the first connector portion, the second connector portion, and the third connector portion are each configured to removably interconnect to one another.

20. A customizable pet chew toy, comprising:
a connector housing;
a first connector portion of the connector housing for attaching a first chew toy;
a second connector portion of the connector housing for attaching a second chew toy;
a third connector portion of the connector housing for attaching a handle accessory;
wherein, the first connector portion, the second connector portion, and the third connector portion are interchangeable with one another to customize the pet chew toy between at least one of a first configuration of the first chew toy and the second chew toy, a second configuration of the first chew toy and the handle accessory, and a third configuration of the second chew toy and the handle.
